(19) United States
(12) Patent Application Publication
(10) Pub. No.: US 2002/0007237 A1
(43) Pub. Date: Jan. 17, 2002

(54) Method and system for the diagnosis of vehicles

(76) Inventors: Tam A. Phung, Sunnyvale, CA (US); Lan T. Phung, Sunnyvale, CA (US)

Correspondence Address: FLEHR HOHBACH TEST, ALBRITTON & HERBERT LLP, Suite 3400, Four Embarcadero Center, San Francisco, CA, 94111-4187, US

(21) Appl. No.: 09/880,989

(22) Filed: Jun. 13, 2001

Related U.S. Application Data
(60) Provisional application No. 60/211,611, filed on Jun. 14, 2000.

(51) Int. Cl. G06F 7/00

(52) U.S. Cl. 701/33; 701/29; 709/219

(57) ABSTRACT

The present invention provides a method and apparatus that identifies vehicle profiles and capture diagnostic symptoms and the resolution for repair. In the disclosed embodiments, the system collect diagnostic information from the vehicle modules, analyze the data, prioritize optimum solutions, and recommend the most likely optimum solution. In an exemplary method, the system can direct the technician through repair steps with the present invention interface. In another exemplary method, whereby the user is a consumer, the system provides customer-friendly current and history vehicle malfunctions, most likely repair options, cost estimations, repair service center recommendations, and other auto service information. In the disclosed embodiments data mining technology is utilized to correlate symptoms and vehicle information with resolutions.

### RELATED APPLICATIONS

This application claims priority to provisional application Ser. No. 60/211,611 filed Jun. 14, 2000.

### BRIEF DESCRIPTION OF THE INVENTION

The present invention relates generally to a method and system for the diagnosis of vehicles, and more particularly to a system for conducting interactive intelligent vehicle diagnosis over an electronic network.

### BACKGROUND OF THE INVENTION

The desire for safer, more comfortable driving, and for environmentally friendly vehicles is leading to a rapid increase in the use of electronics and sensors in modern vehicles. The complexity that results has made it more and more difficult and expensive to diagnose faults and resolve them within a reasonable time.

In addition to the existing diagnostic problems resulting from the challenges of troubleshooting single point defects, new proposals and government regulations are forcing automakers to seek out more effective diagnoses for emission related failures. All 1994 and subsequent model-year passenger cars, light-duty trucks, and medium duty vehicles sold in the United States are required to turn on the “Check Engine Soon” malfunction indicator light (MIL) located on the instrumental panel to inform the operator in the event of a malfunction that causes an increase in emissions above a regulated level.

Typically when a customer encounters such a “Check Engine Soon” light, the customer takes the vehicle into the dealership for service if it is still under warranty. The dealership technicians use service manuals published by automakers to troubleshoot. Some technicians become experts with particular subsystems. However, many less experienced technicians find themselves being pressured to keep up with the pace required to fix vehicles as quickly as possible. Consequently, customers find themselves making multiple visits to the dealership for problems that were not solved during previous visits. The automaker absorbs the cost of all repairs needed to resolve the failure. Consequently, automakers spend several billion dollars a year on warranty repairs, some of which could be due to misdiagnosis, lack of qualified technicians, and other reasons. Misdiagnosis is increasing costs for customers, increasing the manufacturer's costs for warranty work, lowering consumer confidence in brands with bad service reputations.

If the vehicle is not under manufacturer's warranty, the customer is charged by auto service centers (e.g., dealers, large retail chains, and repair shops) to diagnose and fix the problem. The cost of these repairs can range widely depending on many factors. Many consumers are not knowledgeable enough in vehicle technology to question any charges incurred. As a result, consumers are facing higher costs with repeat visits to service centers due to ineffective diagnosis and repair of the failed systems.

There is currently no convenient way for consumers to quickly get a description of the reasons why the “Check Engine Soon” MIL is on, estimates of the repair options, recommendations of service centers, and other relevant information.

Furthermore, service and diagnostic information is not currently aggregated, processed, and disseminated in a way that makes the auto repair process optimal an efficient through the use of an intelligent and adaptive knowledge database.

### SUMMARY OF THE INVENTION

The present invention enables the aggregation of diagnostic and service information from program controlled systems, the tier service community, manufacturers, and other relevant parties. The invention provides a means to effectively communicate diagnostic analysis utilizing the inventive apparatus and implemented computer network system.

The inventive solution provides a platform allowing information flow and sharing among tier levels of user systems. The channels of distribution can be described in three tiers. Tier one may include independent repair shops where single or multi-user systems access up-to-date information and solutions through the Internet or through a dedicated server located at the shop. The information is kept updated by routine refresh processes. Additionally, a network of tier-one repair shops can exchange ideas, experiences, and case history. Tier two may include nationwide service centers, i.e. Dealerships, whereby multi-user systems allow technicians to access up-to-date information and solutions through a dedicated server located at the service center. The information is kept updated by routine refresh processes. Tier three may include original equipment manufacturers, e.g. automakers or part suppliers can access repair cases and find repair trends for future designs and warranty repair processes improvements. Unlike static systems, the invention historical data is dynamic with new cases being added daily from tier one and tier two repair centers, giving manufacturers a method to identify fault trends faster.

One object of the present invention is to provide a system and method whereby diagnostic information from recorded transactions dynamically builds a knowledge base repository in an implemented central data system via the Internet. In addition to problem trends, returning or “unsuccessful” repair cases are tracked and are intelligently manipulated and factored into future repair recommendations. The knowledge base repository is created by a multitude of diagnostic transactions that will delineate diagnostic cases and scenario solutions upon request. In due course, the sophistication of the knowledge base will rapidly increase with each recorded transaction. Ultimately, the database will intelligently converge to optimum repair recommendations. The optimum level of intelligence would provide the most direct diagnostic solution via a plurality of requests processing (e.g., search engine, query processes, troubleshooting methods, or the like). In an alternative embodiment the system will provide a plurality of diagnostic solutions wherein knowledgeable users make selections from the options retrieved. In yet another level, the system will guide the user through diagnostic trouble trees. The inventive system records user navigation actions and measurement results, whereby learned intelligence is utilized to correlate these records with diagnostic symptoms to adapt for future transactions.

In accordance with another aspect of the invention, there is provided a central data system with a global database system that communicates with the inventive apparatus and local network system via the Internet. In the preferred embodiment, the information is transmitted via a wireless medium between the inventive apparatus and the inventive local network system. In an alternative embodiment, the inventive apparatus and the program controlled diagnostic system communicate asynchronously to the central data center modem server through digital wireless technology. The inventive apparatus can provide voice/audio capabilities. The hardware for the program controlled diagnostic system could differ with the appropriate communication protocols needed to establish communication links with the inventive network.

The inventive system can be a stationary or mobile computer, a portable wireless device, a computer workstation, an interactive kiosk, a personal digital assistant, an interactive wireless communications device or the like which can interact with the inventive network. Additionally, the various inventive apparatuses will be fully integrated.

In accordance with another aspect of the invention there is provided an open platform software interface whereby an action of confirmation for completion facilitates directives to capture diagnostic codes, current and historic diagnostic information, and non-voltage ramp information. In one embodiment, the platform provided is a web-based technology having html links, digital graphics, and traditional web capabilities.

In another embodiment, the invention provides wireless communication between the inventive system and an audio device such as a headset. Directives trigger procedures and examination of possible diagnostic solutions via voice recognition, user interface, and navigation technology.

In accordance with another aspect of the invention, there is provided recommended repair information whereby a user may receive the information via email, printout, or wireless means. The repair information can be a plurality of options related to repair cost estimates, parts inventory, repair station schedules, recommended service stations, advertisements, promotions, repair reminders, and other repair characteristic profiles. The information is coupled with vendors and repair service centers whereby bids may be obtained for repair options.

In accordance with another aspect of the invention, there is provided a system and method whereby a database is utilized for datamining manipulations coupled with neuro-networking technology and machine learning intelligence for smart diagnostic algorithm processing. There is provided a statistical probability routine which aggregates collected repair case information and determine the most probable fixes taking factors, e.g. labor intensity factors and forward probability predictions, into consideration. It is to be understood that the labor intensity factor is terminology for a metric that characterizes the amount of physical or mechanical actions to complete for a fix or repair recommendation.

In accordance with another aspect of the invention, there is provided a system and method whereby a search database is utilized for alternative diagnostic analysis. The inventive system supports features needed for symptom searches, intermittent cases, or the like where symptom attributes of vehicle system or program controlled system are utilized to return possible directions and options for repair. An exemplary case would be where a vehicle system with a problem does not return a current code for the technician. The symptoms are correlated to historical repair cases having similar vehicle system characteristics whereby direction for the repair is determined based on best fit and historic repair successes. The problem resolution process may be a plurality of retrieval processes, e.g. key word entry search, engine search technology, guided menu-driven directives, and the like whereby symptoms are correlated to repair options.

The technology used to implement the inventive solution is an integrated repair method and apparatus (“the system”) utilizing a sophisticated automated diagnostic system, smart diagnostics, and data warehousing technology. In addition to traditional datamining technology, the inventive method allow the technicians to navigate dynamic trouble diagnostic trees based on problem codes and symptoms to arrive at the most likely causes and fixes quickly and efficiently.

The inventive method's open systems design allows the diagnostic solution to learn new ways of diagnosing and fixing problems. These new methods are added back to the methods and solutions used by the system. The new diagnostic solutions used are captured not only via feedback and/or input from repair cases, but also captured by skilled repair experts, such that the troubleshooting trees can be modified accordingly and refreshed in the back end system.

### BRIEF DESCRIPTION OF THE DRAWINGS

The present invention will be described in the following portions of the specification when taken in conjunction with the attached drawings in which:

FIG. 1A-1B is a block diagram illustrating the system which includes multiple client systems and associated control systems;

FIG. 2A-2B is a block diagram illustrating the database processing system;

FIG. 3 is a block diagram illustrating the process flow for the datamining techniques;

FIG. 4 depicts an exemplary logical design of the data processing that occurs during the problem resolution process for the system.

FIG. 5 is a functional block diagram illustrating the data flow processes of a system client, database system, and program control system;

FIG. 6A is a flowchart illustrating the components involved in the repair process system with the vehicle system as the preferred embodiment;

FIG. 6B is a flowchart illustrating the steps implemented in the vehicle identification process with the vehicle system as the preferred embodiment;

FIG. 6C is a flowchart illustrating the steps implemented in the data collection process with the vehicle system as the preferred embodiment;

FIGS. 6D-6F are flowcharts illustrating the steps implemented in the problem resolution process with the vehicle system as the preferred embodiment;

FIG. 7A-7B is a process flow chart illustrating the actions that occur during the repair process with the use of the system.

### DETAILED DESCRIPTION

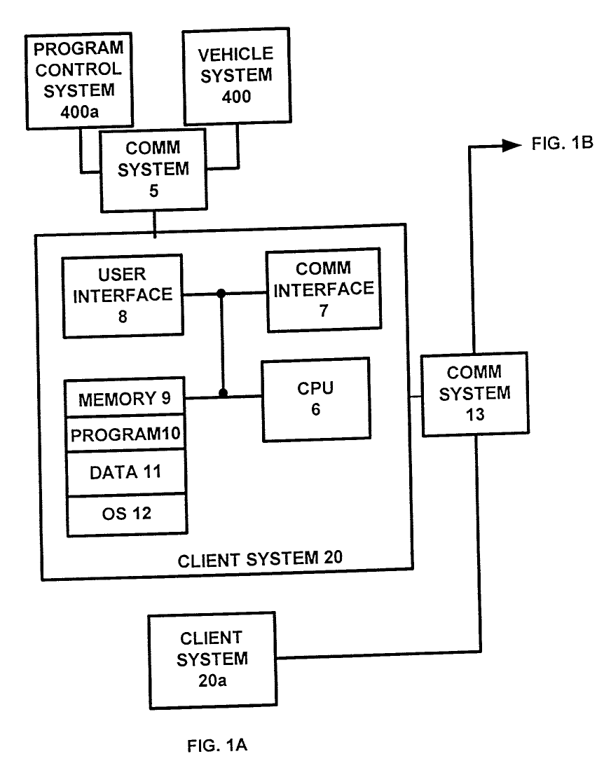

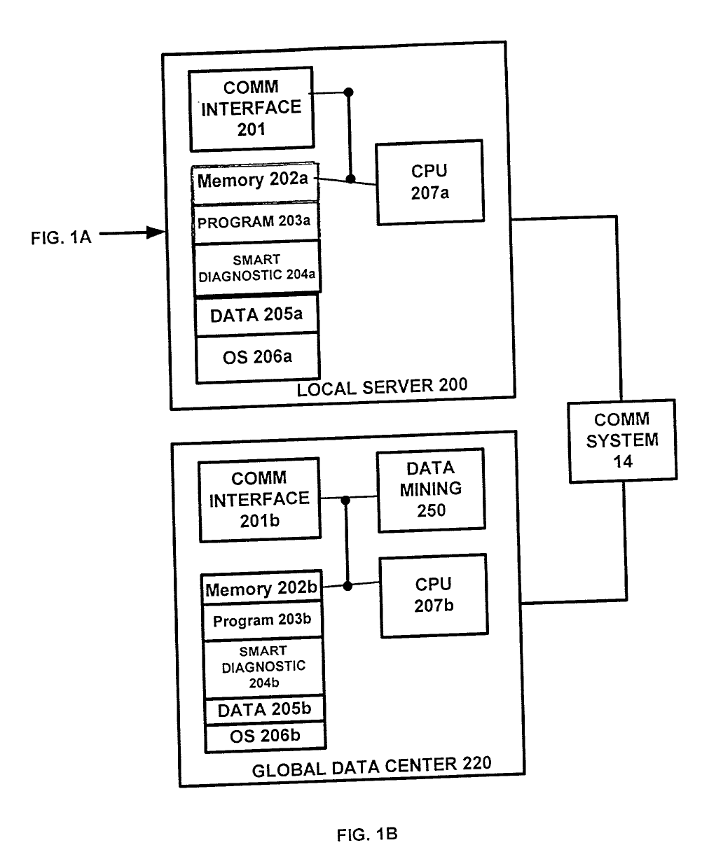

FIG. 1A-1B is a block diagram of one embodiment of an interactive diagnostic system for vehicles in accordance with the present invention. The system includes local server 208, global data center 220 and a plurality of client systems 20 and 20a. Each client system 20, 20a represents a multiple user system. Each local server 208 may represent alliances, networks, or consortiums. The systems 20, 20a, 208, 220, 400, and 400a are communicatively interconnected via communication systems 5, 13, 14. The communication systems 5, 13, 14 can represent any system capable of providing the necessary communication and include for example a local or wide area network such as for example the Internet, either private or public, and other similar communication systems known in the art. The communication system 5 serves as the interface between the client system 20 and vehicle system 400 or program control systems 400a. The communication system 13 serves as the interface between the client system 20, 10a and the local server 208. The communication system 14 serves as the interface between the local server 208 and the global data center 220.

The client systems 20, 20a and the local server 208 include a typical user interface for input/output, and can include wireless networking capabilities, a keyboard, display and other conventional devices. Within each client system 20, 20a, the user interface 8 is coupled to a communication interface 7 that is in turn connected to communication systems 5, 13. Both the user interface and communication interface are also connected, at each client system, to a CPU 6. Each system includes a memory 9, which can further be broken down into a program partition 10, a data partition 11 and an operating system partition 12. Other peripherals may be connected, e.g. printer, email, voice activation device, wireless device. Within the server 208 and global data center 220, the communication interface 201a, 201b are connected to the communication systems 13, 14. The communication system 14 provides a communication interface which is connected to a CPU 207a, 207b. The local server 208 and global data center 220 include memory 202a, 202b, which can further be broken down into a program partition 203a, 203b, a smart diagnostic/neural network partition 204a, 204b, a data partition 205a, 205b, and an operating system partition 206a, 206b.

In each system the CPU (6,207) represents a source of intelligence when executing instructions from the Memory (9,202) so that appropriate input/output operations via the user interface and the communications interface take place as is conventional in the art.

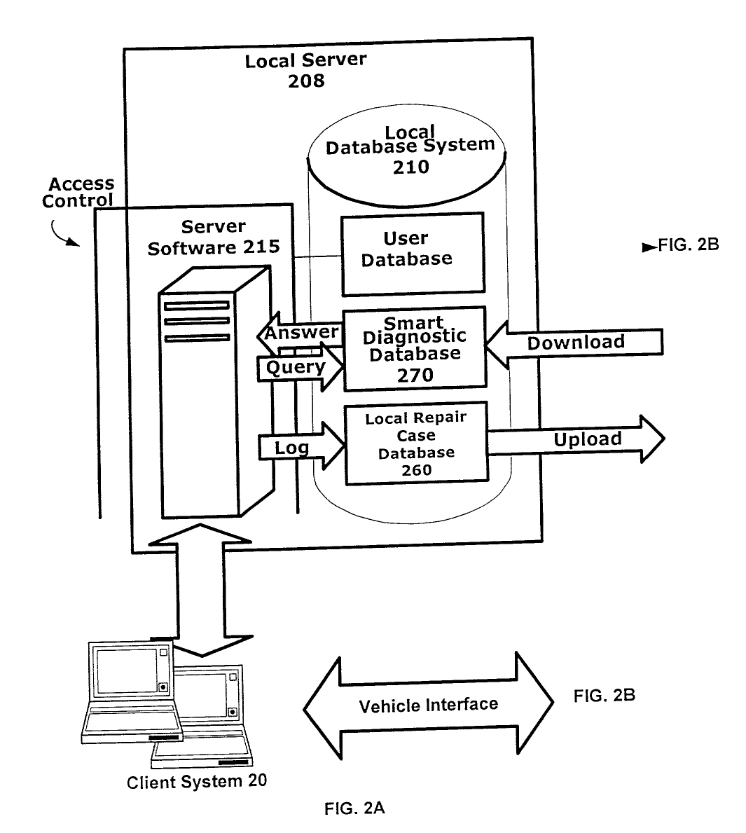

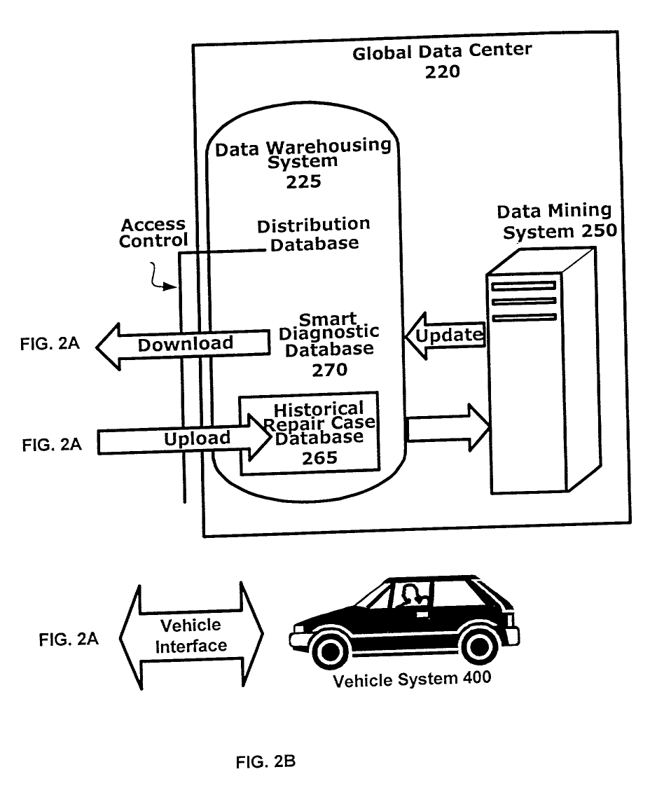

FIG. 2a-2b shows in greater detail the local server 208 and global data center 220 of FIG. 1a-1b. Hereafter, the local server 208 and global data center 220 taken together will be referred to as the database system 200. As illustrated in FIG. 2a-2b, the local database system 210 and the data warehousing system 225 are networked to synchronize the smart diagnostic database 270, local repair case database 260, and historical repair case database 265. There is also inter-connectivity between the data warehousing system 225 and the datamining system 250, which is in turn synchronized to the local database system 210. The local server 208 is networked to the client system 20 by which queries and logs are received by the local database system 210.

It should be noted that the query process represents a two-way communication data path between system server software 215 and local database system 210. A query answer process occurs which exchanges data. For example, if smart diagnostic information is requested from the system server software 215, the requested information is facilitated by the local database system 210. Further, the database system 200 is comprised of all necessary database tables, records and like in addition to mentioned databases to support the system.

A batch upload from the local database system 210 to the global data center 220 is routinely executed to continuously feed the collected data to be processed for up-to-date datamining and probability/statistics calculation processing. In addition to the batch upload, a download of data file updating of previous repair cases are also sent to the global data center 220. An import routine would then process the data in the global data center 220. The import routine parses the local database system 210 files into a multitude of databases that are categorized for datamining and fundamental database efficiency, i.e. by make, model, and year. The local database system 210 would also parse update files as the global data center 220 designates download files in a specified format including the probability weight percentages and other field records. The check records in the local database system 210 would also be updated.

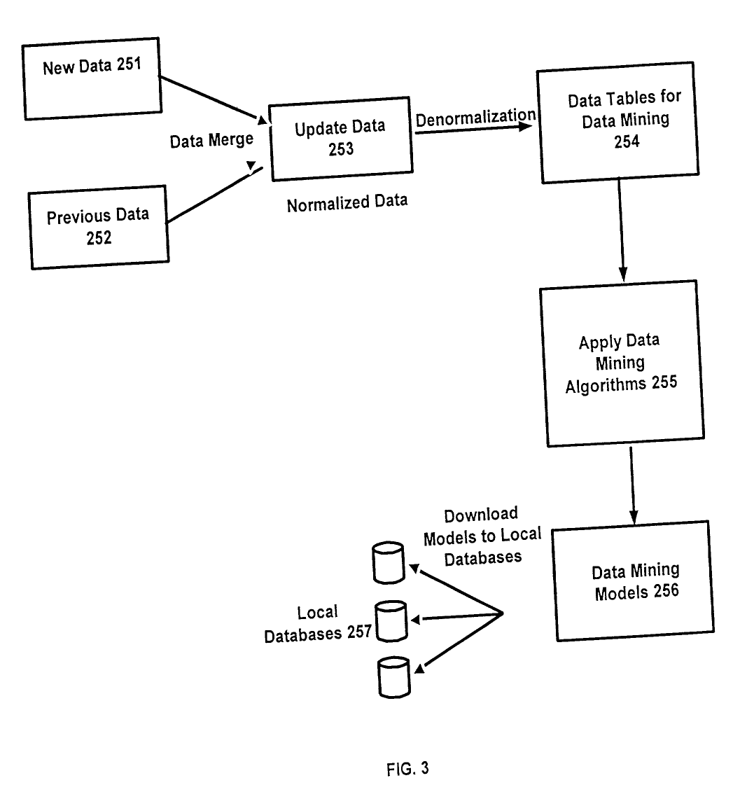

FIG. 3 depicts an exemplary process flow of the application of datamining techniques for the inventive system. The datamining techniques applied to collected data in smart diagnostic routine includes probability, statistical, and machine learning results. As depicted in FIG. 3, new data 251 refers to data collected at dealerships/service stations using client system 20. The new data collected may include vehicle identification number, make, model, engine type, parameter ID, and the like. This data is stored in a local database system 210 residing at the client site, such as the dealership/service station, and is uploaded to the global data center 220 on a regularly scheduled basis. Additionally, the global data center 220 has historical data on repairs previously uploaded to the site. The new data uploaded from the dealerships/service stations is merged with the previous data held in the global data center 220. This data is stored in a set of normalized data tables 253. As needed, the data in the normalized data tables is denormalized into a form 254 appropriate for use by various datamining algorithms 255. Various datamining techniques are applied to the data to build models to be used for diagnosis. These datamining techniques include, but are not limited to, statistical methods for estimation, prediction, regression, and correlation analysis. The purpose of these algorithms is to build models that take as input some combination of data including, but not limited to, trouble codes, PID values or symptoms in order to determine patterns in the data that can be used for the diagnosis of vehicles. The models built as a result of datamining, or as a result of manual construction, can be downloaded to the local databases/application servers 257 at the dealerships/service stations to be used to aid in vehicle diagnosis. These models may supercede or augment existing models stored at the local sites.

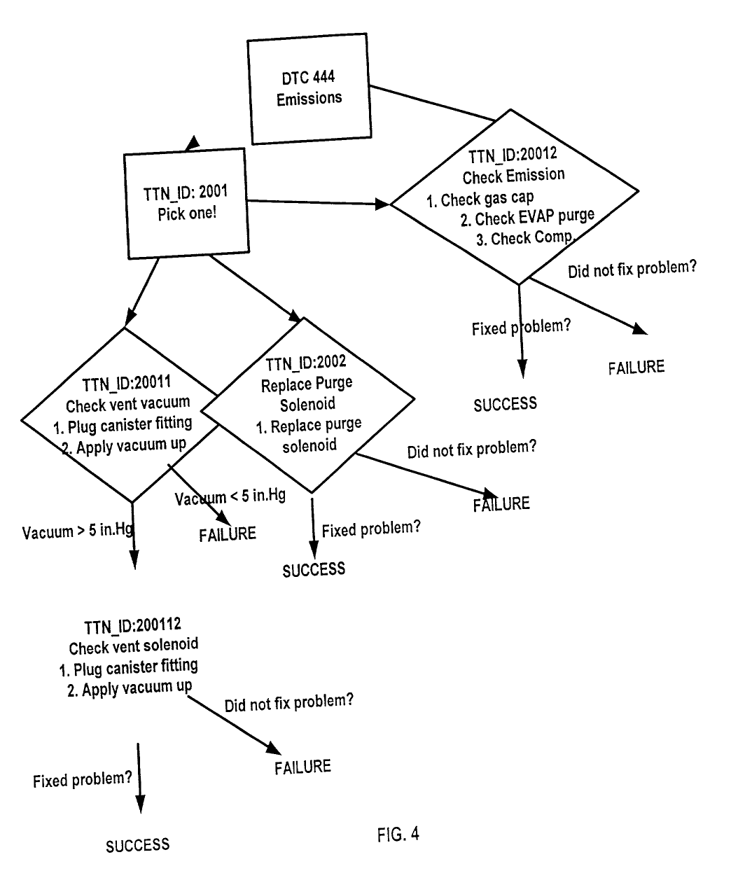

FIG. 4 depicts an exemplary logical design for the data processing that occurs during the problem resolution process. It must be noted that the data provided are artificial and is only used in this particular data model. A diagnostic trouble code (DTC) is associated to a plurality of diagnostic trouble trees (DTTs). It is to be understood that DTC codes are used to define codes that are used in diagnostic procedures serving as an identification to possible problems, diagnostic attributes, and the like. DTTs define trouble trees that are used in the diagnostic procedures serving as a troubleshooting guide. A DTT may involve many checks and actions, which may or may not provide the correct fix for a DTC for a particular vehicle system or program control system. In other words, a DTT can be considered as a procedural black box that returns either “success” or “failure”. A DTT consist of many trouble tree nodes (TTNs). TTNs are the various options that determine the direction of the diagnostic procedures. A check TTN specifies a number of actions and condition/branch pairs. First the actions are performed in sequence, then the conditions are checked. If a condition is found to be true, the corresponding branch is taken. Normally, a branch points to another TTN in the same DTT There are two special cases. A special branch may point to “success,” meaning that a successful conclusion fixed the problem if the condition associated with this branch is satisfied. A special branch may point to “failure,” meaning that a dead end in this branch was concluded without finding a solution to the problem. An option TTN provides a number of independent options for fixing a problem. Each option points to another TTN in the same DTT Client system 20 allows the user to choose an option. At the same time, client system 20 may recommend the best option to the user based on known statistics. If an option eventually leads to “success”, client system 20 should stop at that point and not explore the remaining options. However, if an option eventually leads to “failure”, client system 20 should let the user choose one of the remaining options to explore, until a solution is found. If all options lead to “failure”, then this option TTN becomes a dead end and “failure” is returned.

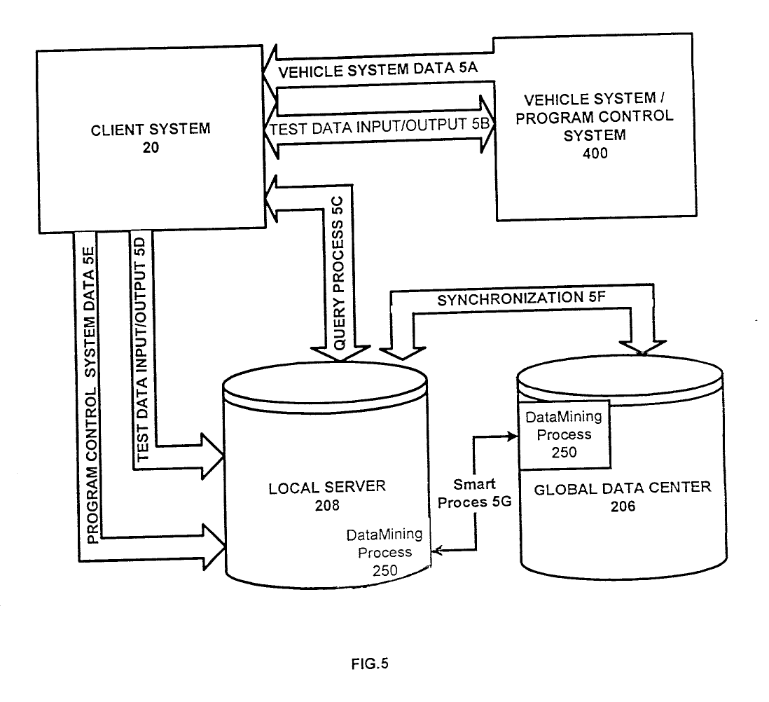

FIG. 5 is a functional block diagram illustrating the communication data path of the major components of the system, which comprises a client system 20, local server 208, global warehousing system 220, and vehicle system 400.

The communication between the client system 20 and vehicle system 400 is accomplished via vehicle system data 5a. In one embodiment, the client system 20 communicates with the vehicle system 400 via a diagnostic link connector or the like. Test data input/output Sb represents a bidirectional communication data path. A translator may be used to translate received serial data into parallel data. The client system 20 receives the repair data pertaining to the vehicle system 400, e.g., vehicle identification number, make, model, and the like. The repair data may also include codes, e.g. trouble codes, diagnostic codes, historical codes, and others. The repair data may also include bi-directional test results, e.g. measurements, system checks, scan results, and the like. The vehicle system 400 may receive bidirectional test requests, e.g. measurements, system checks, scan tests, and other like program requests.

The communication between the client system 20 and local server 208 is accomplished via interface query processes 5C, test data input/output SD, and program control system data 5E. In one embodiment, the client system 20 preferably communicates with local server 208 using a wireless/rf interface. In operation, the local server 208 receives the repair data pertaining to the repair case, e.g. vehicle identification number, make, model, and the like. The repair data may also include codes, e.g. trouble codes, diagnostic codes, historical codes, and others. The repair data may also include bi-directional test results, e.g. measurements, system checks, scan results, and the like. Further, a login process occurs to log repair case information which is communicated to the global data center 220 where it is processed and stored.

The communication between local server 208 and global data center 220, is accomplished via interface synchronization 5F and smart process 5G (comm system 14). In one embodiment, interfaces 5A, 5B, 5C, 5D, 5E, 5F and 5G, represent Internet connections involving public or dedicated data lines. In operation, a synchronization process occurs when data is updated. Further, a datamining process 250 occurs to exchange statistical calculations performed and stored in the global warehousing system 220. Further, it should be noted also that the global data center 220 is not necessarily involved in every operation involving the server 208.

The particular steps used in implementing the inventive system are described in more detail below. In the preferred embodiment, the client system 20 is an interactive hand-held device that communicates to the vehicle system 400 and wirelessly to the local server 208. The database system 200 is comprised of conventional computer machines. In alternative embodiments, the client system 20 can be a conventional scanner, computer workstation or laptop, a local area network of computers, an interactive kiosk, an interactive device or the like which can interact with the network. The vehicle system 400 can be other program control systems 400a, e.g. motor system, robotic system, and any other program controlled machinery.

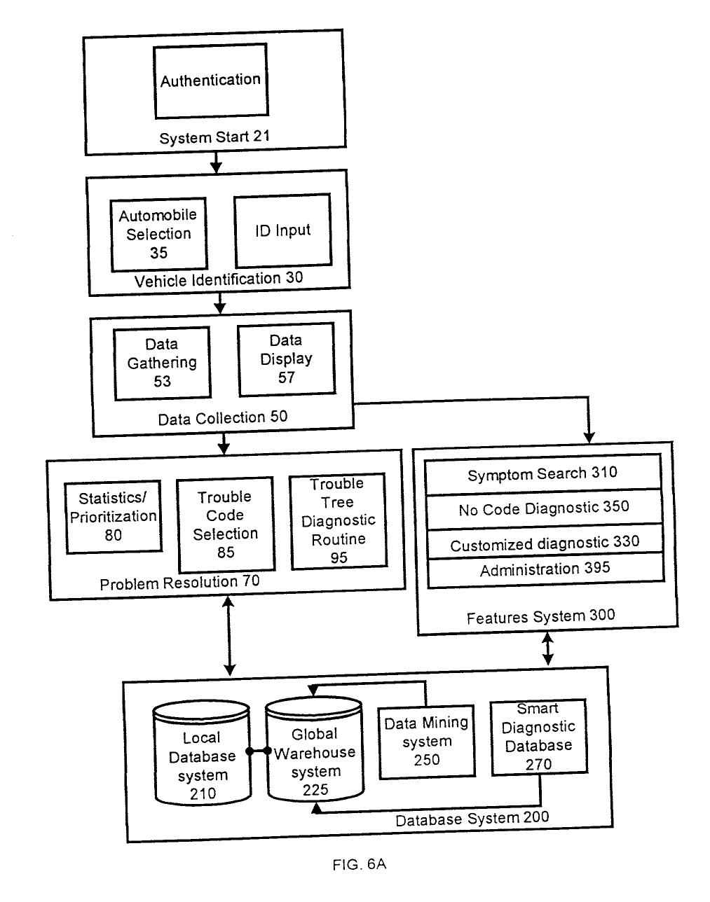

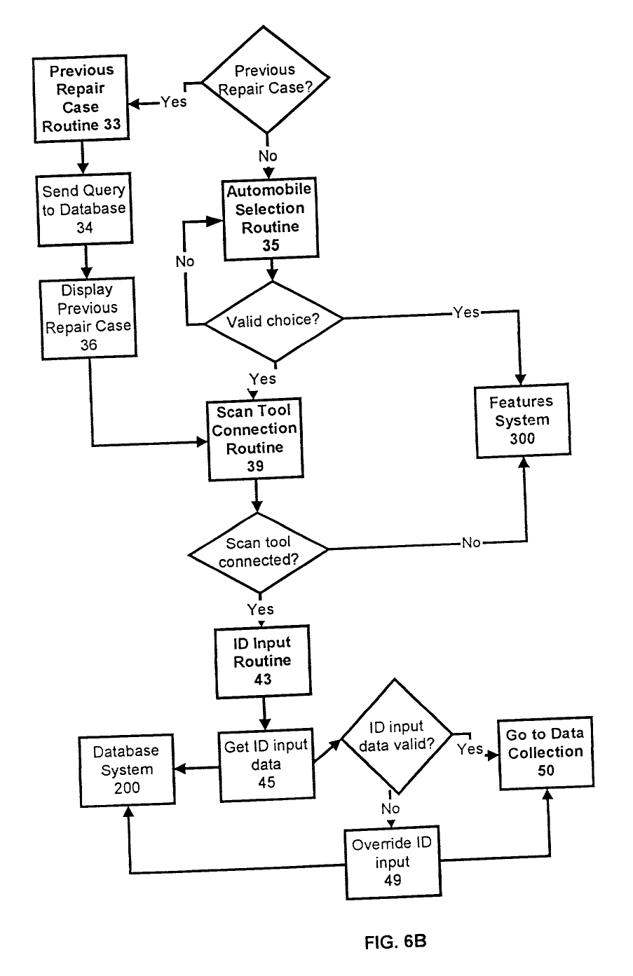

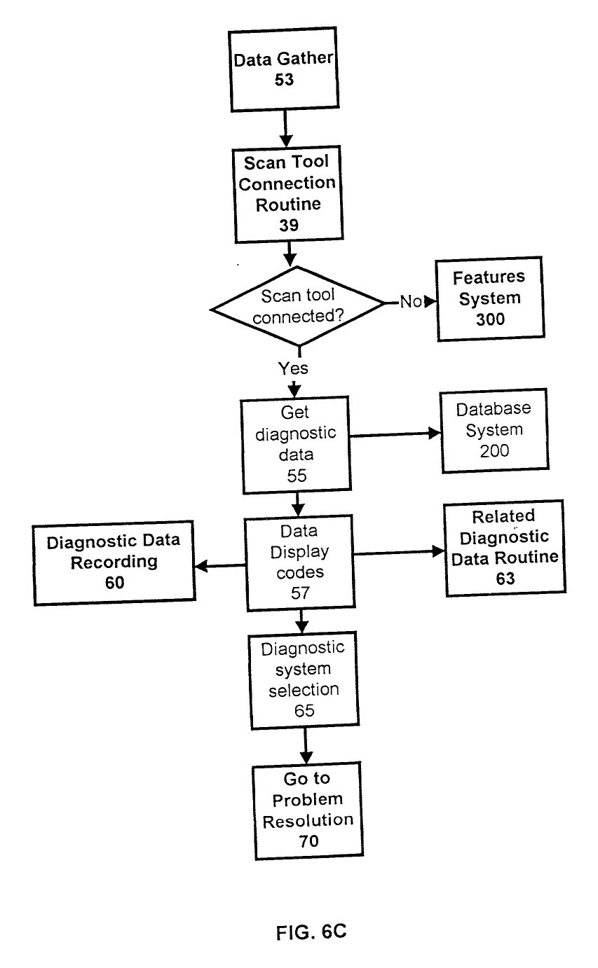

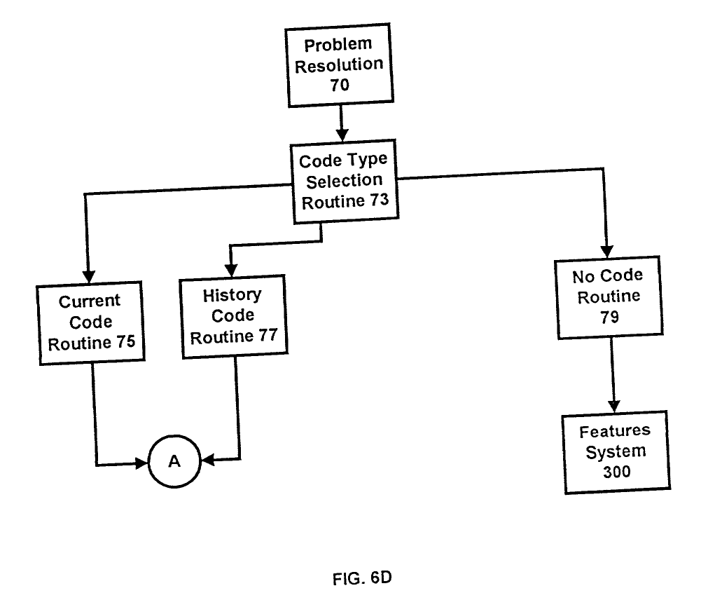

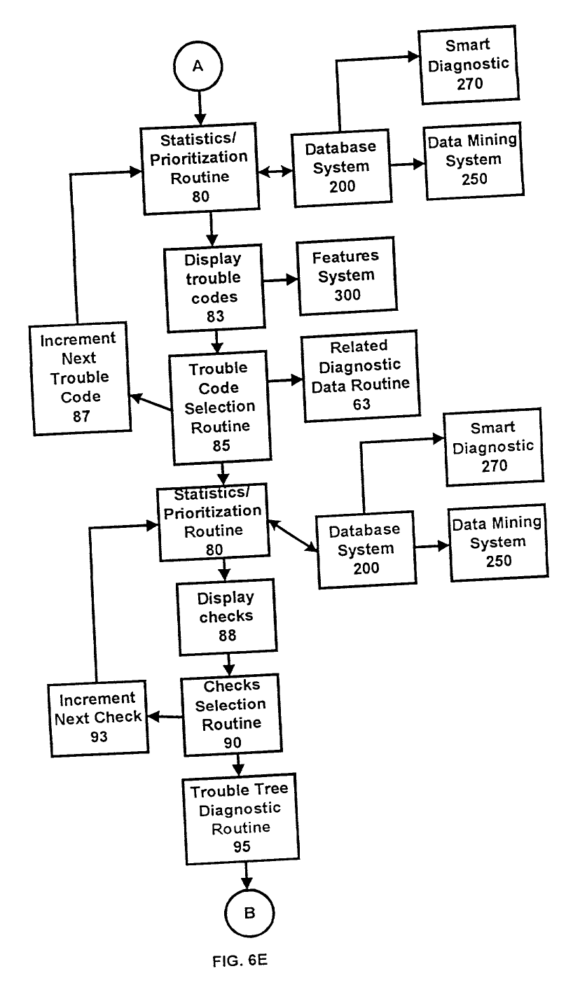

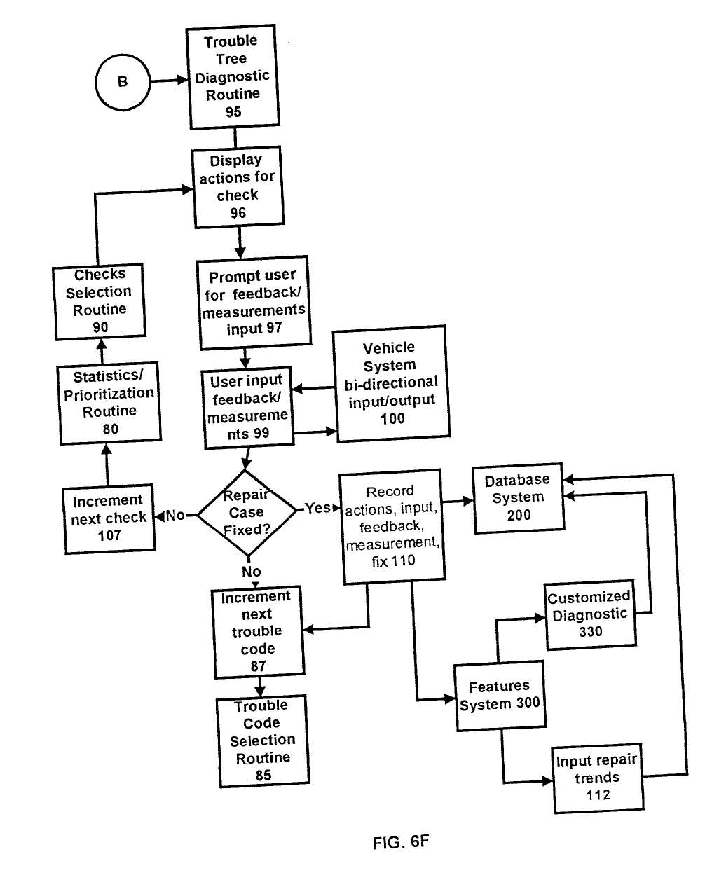

FIG. 6a is a functional block diagram illustrating the diagnostic process using the system. The system start 21 requires the favorable authentication of encrypted personal identification number (PIN) entered by the user. Authentication to facilitate secure transmission of data may be accomplished with appropriate encryption protection, using any number of well-known encryption methods.

The vehicle identification 30 process includes the necessary communication between the client system 20 and the vehicle system 400 to transmit repair data pertaining to vehicle identification information, e.g. vehicle identification number (VIN), model, make, year and the like. The data is transmitted from the vehicle system 400 to the client system 20 to be translated and displayed, and subsequently stored in the database system 200 as a repair case record. Alternatively, the automobile selection 35 process allows a method for a manual data entry of repair data.

The data collection 50 process includes the necessary communication between the client 20 and the vehicle system 400 to transmit repair data pertaining to vehicle diagnostic data, e.g. trouble codes, diagnostic codes, history codes, and the like. The data gathered during the data-gathering 53 process is transmitted from the vehicle system 400 to the client 20 where the data is translated and displayed, data display 57, and subsequently stored in the database system 200 with its associated repair case record. In the case of no available diagnostic data that indicate trouble codes or fault codes, feature system 300 is an alternative option to continue with the repair process.

The problem resolution 70 process consists of steps that the inventive system uses to guide the user to troubleshoot trouble codes or repair problems. The steps include a trouble code selection 85 process that guides the user to evaluate failure codes. Furthermore, a trouble tree diagnostic routine 95 process guides the user to identify possible repair checks and actions towards a solution. The process includes all necessary communication between the client system 20, database system 200, and vehicle system 400. This process includes a statistics/prioritization routine 80 that is processed statistically using machine learning algorithms e.g. neural networks, artificial intelligence, or the like. The algorithms determine probabilities that pertain to the most likely problem resolutions.

Features system 300 is a subsystem of the system that addresses symptoms that are difficult to resolve by way of the inventive problem resolution 70 process. The features system 300 consists of symptom search 310, customized diagnostic 330, no code/intermittent diagnostic 350, and administrative preferences features 395. These additional processes are features that enhance the problem resolution process and can be applied per repair case. An interfacing module is used to allow user flexibility to administer preferences for the usage of the client system 20.

As described with reference to FIG. 2a-2b, the database system 200 consists of the local database system 210 and global warehouse system 225. The database system 200 is where all data is warehoused, processed, and refreshed. Interacting subsystems within the database system 200, such as the datamining system 250 and smart diagnostic database 270, support the adaptive learning processes that occur within the system. The collected diagnostic data gathered during the repair process is continuously merged with existing repair data where the denormalized data is included in the learning algorithm calculations.

FIG. 6b is a flowchart illustrating the steps implemented in the vehicle identification 30 process, FIG. 6a. As shown in FIG. 6b, automobile selection routine 35 is a step where the repair case is identified, selected, or newly entered. In the case of a previous repair case 34, a query process “send query to database 34” is sent to the server 205 for previously stored repair case data to be retrieved as illustrated in previous repair case routine 33. If there was no previous repair case, the automobile selection routine 35 specifies the make of the vehicle and a valid choice provides alternative paths. The scan tool connection routine 39 ensures that the client system 20 is connected to the vehicle system 400 and ready for data to be transmitted. It is contemplated that in other embodiments, this communication would not be necessary. Furthermore, in the case where a user is to use the feature system 300, the scan tool connection would not be required. ID input routine 43 is the step where the vehicle information is either scanned by the client system 20 or entered as input. The transmitted data is downloaded into the database system 200 where it would be stored as described in FIG. 2a-2b. This involves obtaining the ID input data 45, determining its validity and collecting the data, data collection 50. If the data is not valid, the procedure is aborted in the override ID input 49. Further, the features system 300 described in greater detail hereafter is an alternative option.

FIG. 6c is a flowchart illustrating the steps implemented in data collection 50. The scan tool connection routine 39 ensures that the client system 20 is connected to the vehicle system 400 and ready for data to be transmitted during the data gathering process 53. A call routine, “get diagnostic data 55”, is invoked to get diagnostic data from the vehicle system 400. The system receives a bit stream of data where the data is collected by a communication request and response method, e.g. perform diagnostic routine, data transfer, write data block, read data block, etc. The diagnostic data and parameter identifications (PID), e.g. trouble codes, diagnostic codes, history codes, and others, are translated, parsed, and stored in the database system 200. Diagnostic codes pertaining to the subsystems within the vehicle system 400 e.g. power train, body, chassis, and others, are displayed, data display 57. In addition to scanning data, the user interface also provide diagnostic data recording 60 this allows the user to record data from the vehicle system 400. Related diagnostic data is also displayed in the related diagnostic data routine 63. The diagnostic system selection 65 procedure is available to isolate desired diagnostic systems to analyze.

FIGS. 6d and 4f are flowcharts illustrating the steps implemented in the problem resolution 70 process. As depicted in FIG. 6d, the problem resolution 70 process begins with the selection of code type, code type selection routine 73, e.g. current or active codes, history or intermittent codes, no codes, etc. This step determines the direction of the problem resolution method whereby the resolution process is customized according to selected code type. Common cases include analysis of current or active codes, current code routine 75, history or intermittent codes, history code routine 77. In the case of a no code or a difficult vehicle system, the features system 300 is an alternative resolution path.

FIG. 6e illustrates the continuation of the typical troubleshooting resolution path where a statistics/prioritization routine 80 is performed on a selected code type. The database system 200 communicates the datamining system 250 and smart diagnostic 270 program. The calculation results are provided to client 20 where the client application displays the trouble codes “display trouble codes 83” and continues with the troubleshooting process by going to the trouble code selection routine 85.

The statistics/prioritization calculation results are dynamically processed and refreshed for the most probable resolution as the database system 200 accumulates data repair cases. The data repair cases may include information, e.g. user selection, user input, action sequence, navigation, etc. The information is aggregated and analyzed in the datamining system 250 and smart diagnostic 270 process to return repair trends and machine learning results. Concurrently, a knowledge base repository is dynamically built and stored in the database system 200 to be processed in future transactions.

Further, the flexibility of the inventive method allows the user to deviate from the calculated suggested probable resolution path. The user is allowed to select less probable resolution paths and thus ultimately makes the decision on which trouble code routine to continue with in the troubleshooting process. Further, the user may decide to use related diagnostic data 63 to assist in the troubleshooting process. Related diagnostic data may include freeze frame data, parameter identification, repair trends, statistical data, etc., which may assist the user in the troubleshooting process. Upon the result that the selected trouble code was not the problem resolution, the system increments the next code for the next troubleshoot path “increment next trouble code 87”. After the statistics/prioritization routine 80 is re-invoked, the re-calculated results are communicated to the client system 20 for the next troubleshoot trial.

Continuing with the problem resolution 70 process, checks pertaining to the trouble code selected path would also be processed with the statistics/prioritization routine 80. The statistics/prioritization routine 80 communicates calculated results from the database system 200 to the client system 20 based on learned historical repair cases. The most probable repair checks are suggested, display checks 88, however the user ultimately decides on the troubleshooting path via the checks selection routine 90.

Upon the result that the selected check was not the problem resolution, the system increments the next check for the next troubleshoot path, increment next check 93. Further, the repair case data, e.g. user selection, user input, action sequence, navigation, etc. is transferred to the database system 200 from the client system 20 where it is aggregated and stored in the knowledge base repository.

The problem resolution 70 process continuation is depicted in FIG. 6f. Upon completion of the checks selection routine 90 illustrated in FIG. 6e, the trouble tree diagnostic routine 95 is commenced. The actions for the selected check are communicated and displayed, display actions for checks 96, in the client system 20. Actions are the steps that are suggested to be performed to resolve the problem, e.g. trouble options, fixes, measurements, tests, etc. The repair case input and feedback is captured and transferred to the database system 200 where the data is stored. In one embodiment, the user is prompted for feedback and or input, prompt user for feedback/measurements input 97 and user input feedback/measurement 99 procedures. During the problem resolution 70 process there is a method of data transfer between the vehicle system 400 and the client system 20 such that the communication is bi-directional for both input and output depicted as vehicle system bi-directional input/output 100. Upon discovery of a repair case resolution or fix, the user's actions, input, feedback, measurements, and fix (record user actions, input, feedback, measurements, fix 110) is captured and stored in the database system 200.

Further, it must be noted that user has the option to customize the diagnostic troubleshooting trees, as depicted in FIG. 6f, where the features system 300 feature customized diagnostic 330 is available to allow customization. The customization or modification to troubleshooting trees is synchronized in the database system 200 allowing pattern learning to occur dynamically. Further, additional human input for repair trends depicted as input repair trends 112 is an alternative option, which also serves as input to the symptom search 310 database, FIG. 6a.

Upon the result that the problem was not fixed, the user is guided with the next incremented check 107. The troubleshooting process then invokes the statistics/prioritization routine 80 whereby the probability of the most likely check options is recalculated. The checks selection routine 90 is performed where the next selected check would display appropriate actions for the next selected check.

Upon the result that none of the suggested checks resolved the problem or the user selects to troubleshoot an alternative trouble code path, the trouble code selection routine 85 is available for the next trial.

Example of the Invention's Application

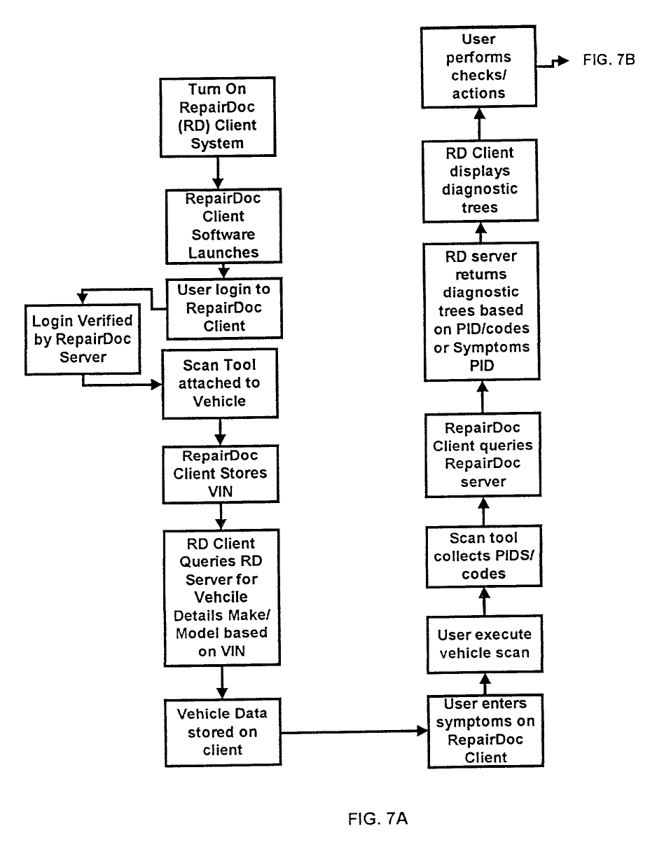

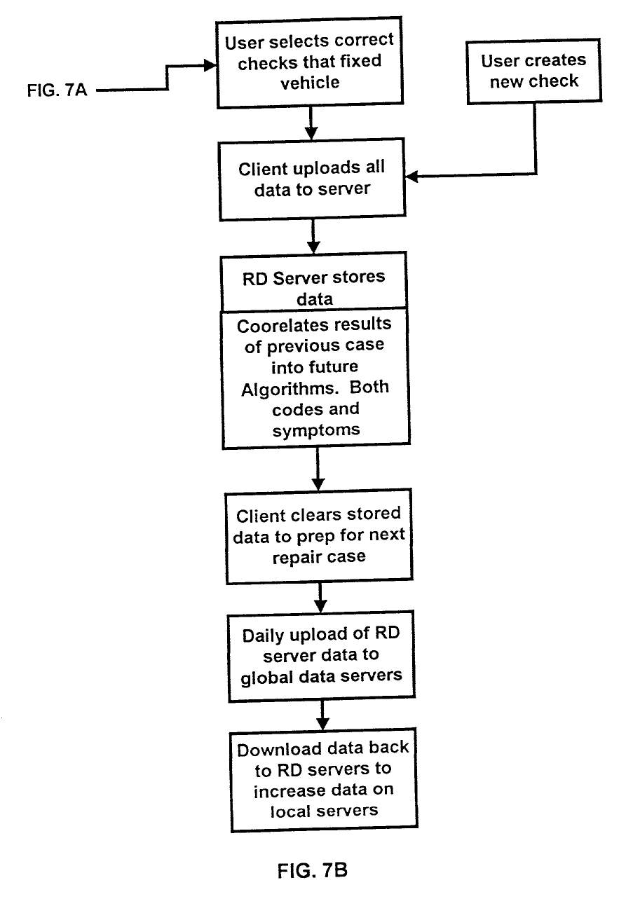

Let us consider an elementary example for the present invention, in order to give a clearer indication of its usefulness and operation. Suppose a technician at a dealership/service center have a service engine light problem with a vehicle that is to be repaired. FIG. 7a-7b is a process flow chart of the actions that occur during the repair process with the use of the inventive system. The client system 20 hardware is powered on and client system 20 software is launched. A prompt requires user to logon. After user's login information is entered, the client system 20 sends user's login information to the local server 208. The local server validates login information against the names and passwords stored in the database. The application server sends validation results to the client system 20. It must be noted that if login is invalid, the client system 20 returns to prompt user to logon. If login is valid, the user attaches scan interface cable between the vehicle and client system 20. User is presented with a list of open requests and an option to create a new request. Assuming a new request is created, the client system 20 polls the vehicle for vehicle identification number (VIN) and sends it to the local server 208. After the local server determines vehicle make, model, engine type and year, based on VIN, the application server returns vehicle details to client system 20. The client system prompts user to enter vehicle symptoms. User can elect to run a symptom search to retrieve diagnostic trees from local server 208. If user does not elect to run a symptom search, the user selects the desired vehicle system to scan and initiates scan. The client system 20 polls the vehicle and returns engine readings and any diagnostic codes that were set. The client system 20 queries the local server 208 for a description of the codes and readings that were returned by the vehicle. Furthermore, the description of the codes and readings are available to be displayed to the user. The user can elect retrieve diagnostic trees from the local server 208 based on a returned code. If no codes are returned by vehicle, the user can still run a symptom search to retrieve diagnostic trees based on symptoms. Local server 208 returns diagnostic trees to client system 20 and presents user with most likely checks to perform to fix vehicle. User performs checks and indicates whether the check fixed, partially fixed, or did not fix the vehicle. This data is stored on the client system 20. User continues performing checks until the correct check is found or user can create a new check using a wizard on the client system 20. The following information is sent from the client system 20 to the local server 208 where it is stored for future analysis and/or retrieval: vehicle description (make, model/year/engine type/etc.), history of all scans performed on each system, history of all codes and engine readings returned by vehicle, symptoms entered by user, history of all checks performed and the result of the checks, any new checks entered by user. Local server 208 stores data sent by client system 20 and uses it to improve the accuracy of the algorithm results. Client system 20 clears client data to prepare for the next request.

On a regular basis, local server 208 will upload all new activity to global data center 220 where it can be processed in aggregate. Furthermore, global data center 220 will download aggregate activity to local server 208 so that local server 208 can benefit from information uploaded by other local servers 208 from other locations.

What is claimed is:

1. A diagnostic system including
a client system including a user interface for input of vehicle and user information and for output of diagnostic information,
a local server for serving one or more client systems configured to store vehicle information and diagnostic information whereby the client system can input information and retrieve diagnostic information, and
a global data center for serving a plurality of local servers, said local data system receiving information for said plurality of local servers, storing and correlating such information and providing diagnostic information.

2. A diagnostic system as in claim 1 including a vehicle interface for providing vehicle information to the input of said client system.

3. A diagnostic system as in claim 1 in which the information supplied from the client system includes vehicle identification and repair information.

4. A diagnostic system as in claim 1 in which said local server stores the repair history of vehicles.

5. A global data center for collecting, processing and storing vehicle data including
memories for storing data, including vehicle profiles (e.g. model, make, year), current diagnostic information (e.g. diagnostic codes) and vehicle histories (e.g. maintenance and repair), and
a processor configured for datamining said stored data and providing diagnostic information.

6. A global data center as in claim 5 including a data storage means which contains records of all transactions and the repair and maintenance history of vehicles, which users (e.g. appraisers, consumers, dealers) can use to identify “lemon” vehicles.

7. A diagnostic system as in claim 1 including a knowledge data source which contains patterns and intelligence which can be used by all relevant users (e.g. auto makers, suppliers, dealers, EPA, consumers) to diagnose the actual condition of a vehicle and anticipate and predict failures (e.g. component and subsystem) based on past experience and expert training of the neural network.

8. A diagnostic system as in claim 1 which is configured to determine maintenance needs and increase the reliability and availability of the vehicle by minimizing the consequences of defects.

9. A vehicle diagnostic system including
a user system for reading vehicle diagnostic codes from a vehicle,
a data center providing repair options for each of said codes, said data center configured to receive, accumulate and process repair information from repair cases to arrive at said repair options, and
a user interface for describing the diagnostic codes in user-friendly terms, and providing the user with repair options obtained from said data center.

10. A vehicle diagnostic system as in claim 9 in which said data center provides estimates for the cost of said repair options.

11. A vehicle diagnostic system as in claim 9 in which the data center is configured to prioritize and display the diagnostic codes with relevant trouble trees and service repair procedures.

12. A data center for a vehicle diagnostic system comprising
a central processing system configured to collect diagnostic information including symptoms and solutions for repair,
correlating said information with vehicle identification,
analyzing said information and determining repair options for given vehicles.

13. A data center as in claim 12 in which said processing system further provides the user with repair steps.

14. A data center as in claim 12 in which said processing system further provides a history of vehicle malfunction.
